(19) United States
(12) Patent Application Publication
(10) Pub. No.: US 2010/0296036 A1
(43) Pub. Date: Nov. 25, 2010

(54) Semi-transparent reflector with plural reflecting surfaces and liquid crystal display unit using the same

(75) Inventor: Gen FUJII, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 12/805,512

(22) Filed: Aug. 3, 2010

Related U.S. Application Data
(62) Division of application No. 10/245,369, filed on Sep. 18, 2002.

(30) Foreign Application Priority Data
Sep. 26, 2001 (JP) 2001-293960

(51) Int. Cl. G02F 1/1335

(52) U.S. Cl. 349/114

(57) ABSTRACT

A semi-transparent reflecting plate including plural reflecting surfaces extending substantially over an entire surface of a reflecting plate, not only permitting light to pass therethrough, but also reflecting the light on the reflecting surfaces.

### CROSS-REFERENCE TO RELATED APPLICATION

This application is a divisional application of U.S. application Ser. No. 10/245,369, filed on Sep. 18, 2002, which claims benefit of priority from Japanese Patent Application No. 2001-293960 filed on Sep. 26, 2001.

### FIELD OF THE INVENTION

This invention relates to a liquid crystal display unit and, more particularly, to a semi-transparent type liquid crystal display unit and a semi-transparent reflection plate used therein.

### DESCRIPTION OF THE RELATED ART

In the following description, term “liquid crystal display panel” is indicative of the combination of a pair of substrate structures and liquid crystal confined therebetween. A liquid crystal display unit includes the liquid crystal display panel and a back light unit, by way of example. The liquid crystal display units are broken down in three categories. The first category is of the type having a back light unit. Light radiates from the back light unit through the partially transparent liquid crystal layer so as to produce a visual image on an image producing plane of the liquid crystal layer. The second category is of the type having a reflection plate. The liquid crystal display units in the second category do not have any back light unit, but are equipped with the reflection plates on the opposite side of the image producing planes. Light is incident on the image producing plane, and passes through the partially trans-parent liquid crystal layer. The light is reflected on the reflection plate, and backward proceeds through the partially transparent liquid crystal layer so as to produce a visual image on the image producing plane. The liquid crystal display units in the first category and the liquid crystal display units in the second category are hereinbelow referred to as “transparent type liquid crystal displays” and “reflection type liquid crystal display units”, respectively.

The third category is a compromise between the transparent type liquid crystal display unit and the reflection type liquid crystal display unit. The liquid crystal display unit in the third category has both of the back light unit and the reflection plate. Light is incident on the image producing plane, and reaches the reflection plate through a partially transparent liquid crystal layer. The back light unit emits light through the reflection plate. The reflected light and radiated light pass through the partially transparent liquid crystal layer so as to produce a visual image on the image producing plane. The liquid crystal display units in the third category are referred to as “semi-transparent type liquid crystal display units”.

The semi-transparent type liquid crystal display units are economical, because the back light and ambient light are selectively used for producing the visual image. While the ambient light is much enough to produce a visual image, the back light unit is turned off so that only the reflection of the ambient light participates in the image production. When the ambient light is reduced, the back light unit turns on, and supplements the light to produce the visual image. Thus, the electric power is saved. The power-saving feature is desirable for small-sized electric devices, and the semi-transparent type liquid crystal display units have been employed in portable electric devices such as, for example, mobile telephones.

Two sorts of reflection plates are used in the semi-transparent type liquid crystal display units as well as the reflection type liquid crystal display units. The first sort of reflection plates is provided inside the liquid crystal panels, and is hereinbelow referred to as “internal reflection plate”. On the other hand, the second sort of reflection plates is provided outside the liquid crystal display panel. The reflection plate is referred to as “external reflection plate”. It is possible to use the pixel electrodes as the internal reflection plate. In case where the pixel electrodes are used as the reflection plate in the semi-transparent type liquid crystal display unit containing twisted nematic liquid crystal, hollow spaces are formed in the pixel electrodes. The hollow spaces permit the back light to pass therethrough. On the other hand, the external reflection plate is independent of the components of the liquid crystal display panel, and is provided between the back light unit and the liquid crystal display panel.

FIGS. 1 and 2 show the prior art semi-transparent type liquid crystal display unit of the type having the external reflection plate. The prior art semi-transparent type liquid crystal display unit largely comprises a liquid crystal display panel 1/2/3/6/7/8, a reflection plate 4 and a back light unit 5. The liquid crystal display panel 1/2/3/6/7/8 has a front surface serving as an image producing plane and a reverse surface opposite to the front surface. The reflection plate 4 is assembled with the back light unit 5, and is attached to the reverse surface.

The liquid crystal display panel is broken down into a pair of substrate structures 1/6 and 2/7/8 and liquid crystal 3. The substrate structure 1/6 is spaced from the other substrate structure 2/7/8 by means of a sealing layer and spacers, and the liquid crystal 3 is confined in the space between the substrate structures 1/6 and 2/7/8. One of the substrate structures includes a transparent substrate 6 and a polarizing plate 1. Though not shown in FIGS. 1 and 2, color filters, black matrix and a common electrode are patterned on the inner surface of the transparent substrate 6, and the polarizing plate 1 is attached to the outer surface of the transparent substrate 6. The other substrate structure includes a polarizing plate 2, a transparent substrate 7, and an adhesive compound layer 8. Pixel electrodes (not shown), thin film switching transistors (not shown) and signal lines (not shown) are patterned on the inner surface of the transparent substrate 7, and the polarizing plate 2 is adhered to the outer surface of the transparent substrate 7 by means of the adhesive compound layer 8. The adhesive compound layer 8 serves as a diffuser.

In the prior art liquid crystal display unit, light is reflected on the boundary between the polarizing plate 1 and the air and the boundary between the reflecting plate 4 and the air, because the difference in refractive index is the largest. If the boundaries or reflection surfaces are in parallel to each other, the light reflected on one of the reflection surfaces is propagated through the optical path same as the optical path through which the light reflected on the other reflection surface is propagated. In other words, the direction of the regular reflection on one reflection surface is coincident with the direction of the regular reflection on the other reflection surface.

A visual image is usually carried on the ambient light, and the reflection surface is like a mirror. The image-carrying ambient light is assumed to be incident on the prior art liquid crystal display unit through the image producing plane. The image-carrying ambient light is regularly reflected on the boundary between the reflection plate 4 and the air, and the image-carrying reflection passes through the partially transparent liquid crystal layer 3. When a user moves the prior art liquid crystal display unit into the field of view, the visual image carried on the reflection is overlapped with another visual image defined by the partially transparent liquid crystal layer 3. Thus, a problem inherent in the prior art liquid crystal display unit is vague images.

A solution is proposed in Japanese Patent Application laid-open No. 9-304617. The prior art liquid crystal display unit disclosed in the Japanese Patent Application laid-open is equipped with a reflection plate, on which the incident light is reflected in a direction crossing the incident light at 5 or more degrees. When the user moves the prior art liquid crystal display panel into his or her field of view, the image of partially transparent liquid crystal layer is deviated from the ambient image so that the user can see the clear image of the partially transparent liquid crystal layer.

FIGS. 3, 4, 5 and 6 show the semi-transparent reflection plates 9a, 9b, 9c and 9d disclosed in the Japanese Patent Application laid-open. The semi-transparent reflection plates 9a, 9b, 9c and 9d have different contours.

The semi-transparent reflection plate 9a has a flat surface 9e, and the reverse surface 9f has a saw-toothed cross section. The reverse surface 9f rises at a large angle of elevation, and falls at a small angle of depression. The rise and fall are alternately repeated so that the reverse surface is waved. Although the semi-transparent reflection plate 9a assembled with a liquid crystal display panel is described in the Japanese Patent Application laid-open, the Japanese Patent Application laid-open is silent to which surface 9e or 9f is directed to the back light unit. Nevertheless, it is considered that the flat surface 9e is attached to the reverse surfaces of the liquid crystal display panel as shown in FIG. 2. This means that the waved reverse surface 9f is directed to the back light unit 5.

The semi-transparent reflection plate 9b also has a flat surface 9e, and the reverse surface 9h is waved like prisms arranged in parallel. The flat surface 9e would be also held in contact with the reverse surface of the liquid crystal display panel, and secured thereto.

The semi-transparent reflection plate 9c also has a flat surface 9e, and the reverse surface 9i is waved like an array of pyramids. The flat surface 9e would be held in contact with the reverse surface of the liquid crystal display panel, and secured thereto.

The semi-transparent reflection plate 9d also has a flat surface 9e, and a large number of asymmetrical projections form the reverse surface 9j. The flat surface 9e would be held in contact with the reverse surface of the liquid crystal display panel, and secured thereto.

The prior art semi-transparent reflection plates 9a to 9d include transparent/semi-transparent bodies and reflection layers. The waved surfaces, which are similar to the waved surfaces 9f/9h/9i/9j, are formed on the surfaces of the transparent/semi-transparent bodies. The transparent/semi-transparent bodies are made of glass or synthetic resin, and are 20 microns thick to 5 millimeters thick. The waved surfaces are covered with the reflection layers, and the waving patterns are transferred to the outer surfaces of the reflection layers. In other words, the reflection layers form the waved surfaces 9f/9h/9i/9j.

Several sorts of reflection layers are disclosed in the Japanese Patent Application laid-open. The first sort of reflection layers is made of highly reflective metal such as silver or aluminum. The highly reflective metal is deposited on the transparent/semi-transparent bodies by using a vacuum evaporation, a sputtering or an ion-plating. The highly reflective metal layer has the thickness ranging between 50 angstroms to 400 angstroms.

The second sort of reflection players is made of metal powder containing synthetic resin. The third sort of reflection layers is made of organic/inorganic particle containing synthetic resin. The metal powder or organic/inorganic particles are mixed with binder of synthetic resin, and the waved surfaces 9f/9h/9i/9j are coated with the mixture. The thickness ranges from 5 microns to 200 microns.

Thus, the prior art semi-transparent reflection plates achieve a high reflectivity and a fairly good transmittance. An experiment is disclosed in the Japanese Patent Application laid-open. The sample used in the experiment had the waved surface 9f. The angle of elevation was 7.5 degrees, and the vertical angle of the triangle cross section was 82.5 degrees. The surface 9f was waved at pitches of 200 microns. The body was made of synthetic resin, and the waved surface 9f was coated with a pearl pigment containing acrylic resin layer. The content of the pearl pigment was 30%. Using the sample, the transmittance to the all incident light was measured, and was 35%.

The problem, i.e., vague visual image due to the overlap, is also encountered in the prior art liquid crystal display panel unit equipped with the internal reflection plate. The problem will be solved by forming the waved surface on the internal reflection plate. However, the waved surface makes the fabrication process of the prior art liquid crystal display panel complicated. This results in a large production cost. Moreover, the production yield is drastically decreased. For this reason, the manufacturers take the position that the liquid crystal display units equipped with the external reflection plate is superior to the liquid crystal display unit equipped with the internal reflection plate.

However, the trade-off between the reflectivity and the transmittance is a serious problem inherent in the prior art semi-transparent reflection plates. If the reflection layers are increased in thickness, the reflectivity is enhanced. However, the transmittance is reduced. On the other hand, if the reflection layer is decreased in thickness, the transmittance is improved. However, the reflectivity is reduced. The prior art semi-transparent reflection plate disclosed in the Japanese Patent Application merely achieves the transmittance of 35% on the condition that the reflection layer is made of the pearl pigment containing acrylic resin. If the silver or aluminum is used for the reflection layer, the transmittance would be further reduced.

### SUMMARY OF THE INVENTION

It is therefore an important object of the present invention to provide a semi-transparent reflection plate, which achieves a high transmittance as well as a high reflectivity.

It is also an important object of the present invention to provide a semi-transparent type liquid crystal display unit with the built-in semi-transparent reflection plate.

The present inventor contemplated the problem inherent in the prior art semi-transparent reflection plates, and noticed that the reflection layer, i.e., the metal layer or particle-contained synthetic resin layer had poor light transmission property. The present inventor considered how the reflectivity was enhanced without any metal or particle-contained synthetic resin layer. The present inventor reached an idea that multiple waved surfaces would enhance the reflectivity without any metal or particle-contained synthetic resin layer.

In accordance with one aspect of the present invention, there is provided a semi-transparent reflector having two major surfaces serving as an incident surface and an outgoing surface for a first incident light and vice versa for a second incident light, comprises an optical body made of material permitting the first and second incident light to pass therethrough and having plural waved surfaces serving as plural reflection surfaces to the first incident light without any reflection layer made of another material larger in reflectivity than the material, and the plural reflection surfaces reflect the first incident light in a certain direction different from a direction in which the first incident light is incident on one of the major surfaces.

In accordance with another aspect of the present invention, there is provided a liquid crystal display unit for producing visual images comprising a liquid crystal display panel having an image producing plane and a liquid crystal layer partially changed between transparent state and photo-shield state for producing the visual images on the image producing plane with the assistance of at least one of ambient light incident on the image producing plane and back light, a back light unit for radiating the back light to the liquid crystal display panel and a semi-transparent reflector provided between the light crystal display panel and the back light unit and including an optical body made of material permitting the at least one of the ambient light and the back light to pass therethrough and having plural waved surfaces serving as plural reflection surfaces to the ambient light without any reflection layer made of another material larger in reflectivity than the material, and the plural reflection surfaces reflect the ambient light in a certain direction different from a direction in which the ambient incident light is incident on the semi-transparent reflector.

### BRIEF DESCRIPTION OF THE DRAWINGS

The features and advantages of the reflection plate and semi-transparent type liquid crystal display unit will be more clearly understood from the following description taken in conjunction with the accompanying drawings, in which

FIG. 1 is a fragmentary perspective view showing the structure of the prior art semi-transparent liquid crystal display unit,

FIG. 2 is a front view showing the structure of the prior art semi-transparent liquid crystal display unit,

FIG. 3 is a perspective view showing the contour of the semi-transparent reflection plate disclosed in Japanese Patent Application laid-open No. 9-304617,

FIG. 4 is a perspective view showing the contour of another semi-transparent reflection plate disclosed in Japanese Patent Application laid-open No. 9-304617,

FIG. 5 is a perspective view showing the contour of yet another semi-transparent reflection plate disclosed in Japanese Patent Application laid-open No. 9-304617,

FIG. 6 is a perspective view showing the contour of still another semi-transparent reflection plate disclosed in Japanese Patent Application laid-open No. 9-304617,

FIG. 7 is a fragmentary perspective view showing the structure of a semi-transparent liquid crystal display unit according to the present invention,

FIG. 8 is a front view showing the structure of the semi-transparent liquid crystal display unit,

FIG. 9A is a plane view showing the layout of a part of a liquid crystal display panel incorporated in the semi-transparent liquid crystal display unit,

FIG. 9B is a cross sectional view taken along line A-A7 of FIG. 9A and showing the structure of the liquid crystal display panel,

FIG. 10 is a fragmentary perspective view showing the structure of another semi-transparent liquid crystal display unit according to the present invention,

FIG. 11 is a front view showing the structure of the semi-transparent liquid crystal display unit,

FIG. 12 is a perspective view showing the waved surface of a semi-transparent reflection body forming a part of a semi-transparent reflector according to the present invention,

FIG. 13 is a perspective view showing the waved surface of another semi-transparent reflection body forming a part of a semi-transparent reflector according to the present invention,

FIG. 13 is a perspective view showing the waved surface of another semi-transparent reflection body forming a part of a semi-transparent reflector according to the present invention,

FIG. 14 is a perspective view showing the waved surface of yet another semi-transparent reflection body forming a part of a semi-transparent reflector according to the present invention,

FIG. 15 is a perspective view showing the waved surface of still another semi-transparent reflection body forming a part of a semi-transparent reflector according to the present invention, and

FIG. 16 is a perspective view showing the waved surface of yet another semi-transparent reflection body forming a part of a semi-transparent reflector according to the present invention.

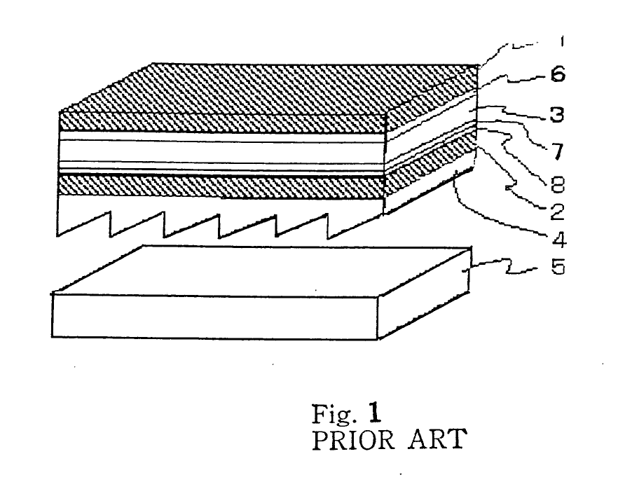

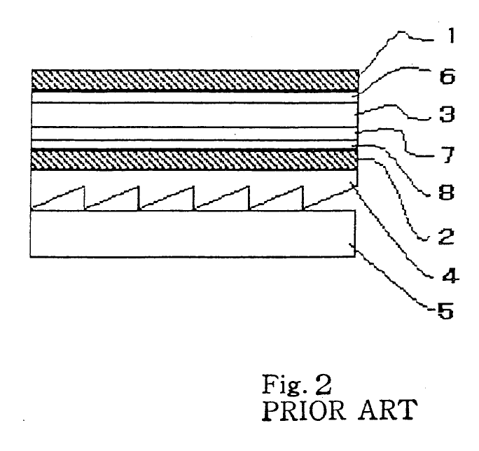

### DESCRIPTION OF THE PREFERRED EMBODIMENTS

### First Embodiment

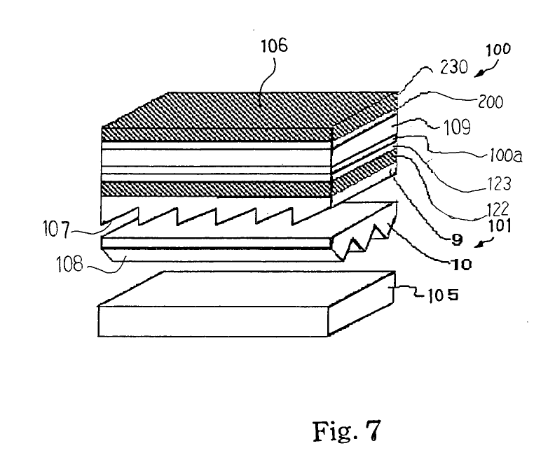

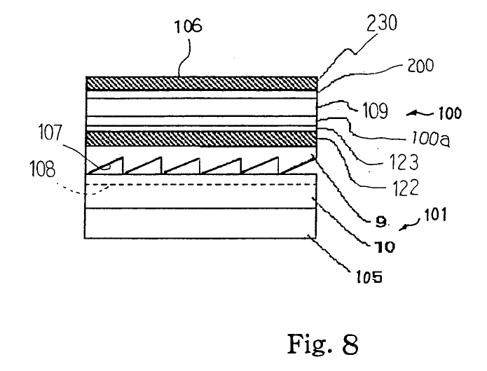

Referring to FIGS. 7 and 8 of the drawings, a semi-transparent liquid crystal display unit embodying the present invention largely comprises a liquid crystal display panel 100, a semi-transparent reflector 101 and a back light unit 105. The liquid crystal display panel 100 has an image producing plane 106, and the semi-transparent reflector 101 is attached to a surface reverse to the image producing plane 106. The back light unit 105 is secured to the semi-transparent reflector 101.

The semi-transparent reflector 101 is made of transparent or semi-transparent substance, and has two, i.e., plural reflecting surfaces 107/108 implemented by waved surfaces. However, neither metal nor particle-contained synthetic resin is formed on the plural reflecting surfaces 107/108. Ambient light, which is incident on the image producing plane 106, is reflected on the plural reflecting surfaces 107/108 toward the liquid crystal display panel 100. Even though the amount of ambient light reflected on each reflecting surface 107/108 is smaller than the amount of ambient light reflected on the metal/particle-contained synthetic resin layer is, the total amount of ambient light reflected on the plural reflecting surfaces 107/108 are larger than the amount of ambient light reflected on the metal/particle-contained synthetic resin layer is. Thus, the plural reflecting surfaces 107/108 enhances the reflectivity of the semi-transparent reflector 101.

On the other hand, the back light, which is radiated from the back light unit 105 toward the liquid crystal display panel 100, passes through the semi-transparent reflector 101. The semi-transparent reflector 101 is not coated with any metal or particle-contained synthetic resin layer. Even though the semi-transparent reflector 101 is thicker than the prior art semi-transparent reflectors 9f/9h/9i/9j are, the transmittance is much larger than that of the prior art semi-transparent reflectors 9f/9h/9i/9j, because the back light does not pass through any highly reflective layer, i.e., metal or particle-contained synthetic resin layer.

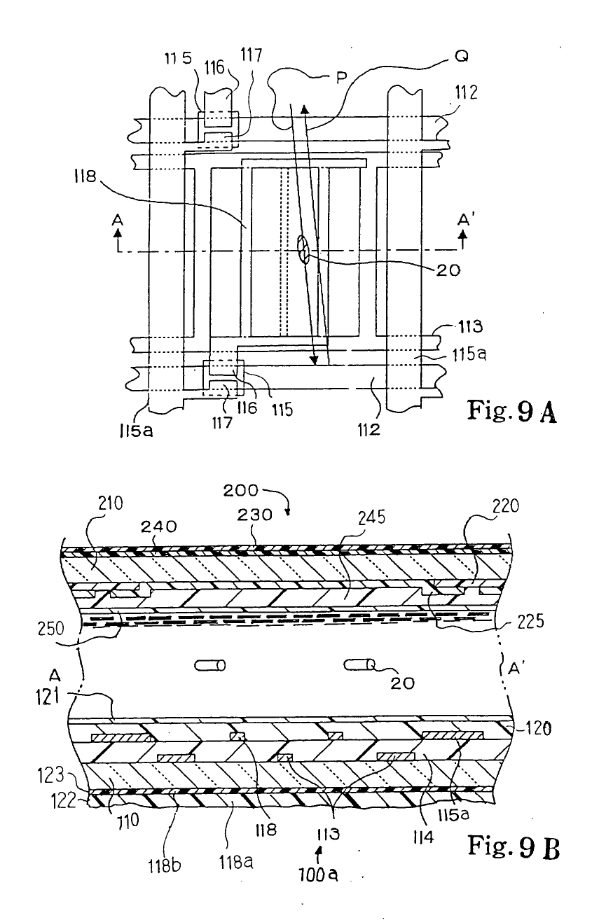

Description is hereinbelow made on the liquid crystal display panel and semi-transparent reflector 101 in more detail. FIGS. 9A and 9B show a part of the liquid crystal display panel 100. The liquid crystal display panel 100 is categorized in the in-plane switching active matrix type.

The liquid crystal display panel 100 largely comprises a pair of substrate structures 100a/200, spacers (not shown), a sealing layer 109 (see FIGS. 7 and 8) and liquid crystal 20. The substrate structure 100a is spaced from the other substrate structure 200 by means of the spacers. The sealing layer 109 extends along the peripheries of the substrate structures 100a and 200, and spacers are scattered inside of the sealing layer 109. The substrate structures 100a/200 and sealing layer 109 define an inner space, and the liquid crystal is confirmed in the inner space.

A plurality of pixels are arranged in matrix in the assembly of the substrate structures 100a/200, and a visual image or images are produced on the image producing plane 106 by means of the pixels. Components of pixels are selectively formed in the substrate structures 100a/200. The pieces of liquid crystal incorporated in the pixels are changed between transparent state and photo-shield state. Ambient light and/or back light passes through the pieces of pixels in the transparent state so that a visual image or images are produced on the image producing plane 106. The other components of the pixels are described hereinbelow in detail.

The substrate structure 100a includes a transparent substrate 110, and gate signal lines 112 and a common electrode 113 are patterned on the major surface of the transparent substrate 100a. Parts of gate signal lines 112 serve as gate electrodes of the thin film switching transistors, and the gate electrodes 112 are hereinbelow labeled with the same reference 112. The transparent substrate 100a is, by way of example, made of glass. The gate signal lines 112 and the common electrode 103 are covered with an insulating layer 114, and amorphous silicon layers 115 are patterned on the insulating layer 114. The amorphous silicon layers 115 are located over the associated gate electrodes 112, and a source region, a drain region and a channel region are formed in each of the amorphous silicon layer 115. In this instance, the insulating layer 114 is made of silicon nitride expressed as SiNx, and partially serves as gate insulating layers of the thin film switching transistors.

Data lines 115a, source electrodes 116, drain electrodes 117 and pixel electrodes 118 are patterned on the insulating layer 114. The source electrodes 116 are respectively held in contact with the source regions in the amorphous silicon layers 115, and the drain electrodes 7 are also held in contact with the drain regions in the amorphous silicon layers 115, respectively. Each source electrode 116, each drain electrode 117 and each pixel electrode 118 form in combination one of the thin film transistor together with the gate electrode 112, part of the insulating layer 114 and the amorphous silicon layer 115.

The drain electrodes 117 are selectively associated with the data lines 115a, and are integral with the associated data lines 115a. On the other hand, the source electrodes 116 are respectively connected to the pixel electrodes 118. When a gate signal line 112 is changed to the active level, pieces of image data information are transferred from the data lines 115a through the thin film switching transistors to the pixel electrodes 118. The gate signal lines 112 are sequentially changed to the active level, and the pieces of image data information are written into the pixel electrodes 118 in synchronism with the change of the gate signal lines.

The source electrodes 116, the drain electrodes 117 and the data lines 115a are made of non-transparent material such as, for example, chromium, and the pixel electrodes 118 are made of conductive transparent material such as, for example, indium tin oxide. The pixel electrodes 118 are arranged in such a manner as to be offset from an associated part of the common electrode 113.

The data line 115a, the source electrodes 116, the drain electrode 117 and the pixel electrode 118 are covered with a passivation layer 120, and an orientation layer 121 is laminated on the passivation layer 120. In this instance, the passivation layer 120 is formed of silicon nitride SiNx. A polarizing plate 122 is adhered to the outer surface of the transparent substrate 110 by means of an adhesive compound layer 123. The adhesive compound layer 123 serves as a light diffuser, and is effective against Moiré due to the interference of light.

The other substrate structure 200 includes a transparent substrate 210. The transparent substrate 210 is, by way of example, formed of glass. The trans-parent substrate 210 is sandwiched between black matrix/color filters 220/225 and a conductive layer 240. The conductive layer 240 is overlaid with a polarizing plate 230. Apertures are formed in the black matrix 220, and each of the apertures is aligned with one of the pixel electrodes 118 and the associated part of the common electrode 113. The apertures are closed with the color filters 225. The color filters 225 are selectively colored in red, green and blue. The black matrix 220 and the color filters 225 are covered with an insulating layer 245, and the insulating layer 245 is made of silicon nitride SiNx. The insulating layer 245 in turn is covered with an orientation layer 250.

The orientation layers 121/250 are formed by using an offset printing, and are subjected to rubbing. In this instance, the molecules of the orientation layer 121 is directed as indicated by arrow P, and the molecules of the other orientation layer 250 is directed as indicated by arrow Q. The liquid crystal molecules 20 are directed in parallel to the rubbing directions P/Q. The polarizing plate 122 permits the ambient light or back light to pass in a direction parallel to the orientation of the liquid crystal molecules 20. On the other hand, the polarizing plate 230 has a light absorbing direction perpendicular to that of the other substrate structure 100a. The polarization plates 122 and 230 are hatched in FIGS. 7 and 8 in order to make the boundaries of the liquid crystal display panel 100 clear. The outer surface of the polarization plate 230 may be subjected to an anti-reflection treatment.

Each of the thin film transistors, associated pixel electrode 118, associated color filter 225 and a piece of liquid crystal 20 as a whole constitute a pixel. Every three pixels, which respectively include the red, green blue filters 23, form in combination a pixel group, and the pixel groups are arranged in matrix. A picture, which consists of plural visual images, is produced on the image producing plane as follows. A driver circuit (not shown) changes one of the gate signal lines 112 to the active level, and causes a row of the thin film switching transistors to turn on. Concurrently, image data signals, which carry pieces of image data information, are supplied to the data lines 115a. The image data signals pass through the thin film switching transistors in the on-state, and the pieces of image data information are written in the associated pixel electrodes 118. The driver circuit sequentially changes the other gate signal lines 112 from the inactive level to the active level and vice versa, and sequentially writes pieces of image data information into the other pixel electrodes 118.

The common electrode 113 is always at a constant potential level, and the pieces of image data information give rise to variation in potential level on the pixel electrodes 118. Then, local electric fields are selectively generated between the pixel electrodes 118 and the common electrode 113, and selected ones of the pieces of liquid crystal 20 change the tilt angle. In other words, selected ones of pixels are changed to the transparent state, and the other pixels are maintained in the photo-shield state. The ambient light or back light passes through the pixels in the transparent state, and produces full-color visual images on the image producing plane. Thus, the pixels are changed in the local electric fields generated between the associated pixel electrodes 118 and the common electrode 113 on the substrate structure 100a. The pixels are referred to as “in-plane switching type pixels”.

Turing back to FIGS. 7 and 8, the semi-transparent reflector 101 includes two reflection bodies 9 and 10. The reflection bodies 9 and 10 are made of transparent substance or semi-transparent substance, and neither metal nor particle-contained synthetic resin covers the surfaces of the reflection bodies 9 and 10. The back light is transmitted through the reflection bodies 9 and 10, and is incident onto the polarizing plate 122. In this instance, the reflection bodies 9 and 10 are made of the substance selected from the group consisting of synthetic resin such as, for example, polyethylene terephthalate resin, polycarbonate resin, polyester resin, polyacrylic resin, glass and ITO (Indium Tin Oxide).

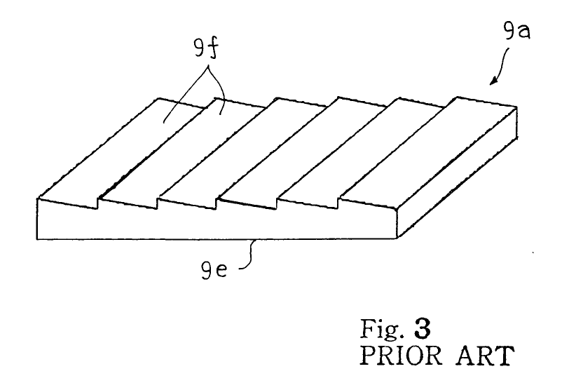

The reflection bodies 9 and 10 have the reflection surfaces 107 and 108, respectively. The reflection surfaces 107/108 are waved like sawtooth, and have ridgelines. The reflection surfaces 107/108 are constituted by plural inclined rectangular flat surfaces and connecting flat surfaces between the inclined rectangular flat surfaces. The reflection surfaces 107/108 are analogous in configuration to the waved surface 9f of the prior art reflector 9a (see FIG. 3). The reflection bodies 9 and 10 further have surfaces, which are reverse to the reflection surfaces 107/108, and the reverse surfaces are flat.

The flat reverse surface of the reflection body 9 is held in face-to-face contact with the polarizing plate 122, and the ridgelines of the reflection surface 107 are held in contact with the flat surface of the other reflection body 10. Prism-like hollow spaces take place between the reflection surface 107 and the flat reverse surface, and the air fills the prism-like hollow spaces. The reflection body 10 is directed in such a manner that the ridgelines thereof are perpendicular to the ridgelines of the reflection body 9. The ridgelines of the reflection body 10 are held in contact with the light output surface of the back light unit 105, and prism-like hollow spaces also take place between the reflection surface 108 and the light output surface of the back light unit 105. There is a large difference in reflectivity at the boundaries between the reflection bodies 9/10 and the air so that the ambient light, which is incident on the image producing plane 106, is reflected on the reflection surfaces 107/108.

Assuming now that pieces of image data information have written in the pixel electrodes 118, the pieces of liquid crystal 20 are selectively changed to the transparent state. The back light unit 105 is not energized. The ambient light passes through the liquid crystal display panel 100, and is incident onto the semi-transparent reflector 101. The ambient light passes through the reflection body 9, and reaches the reflection surface 107. The ambient light is partially reflected on the boundary between the reflection body 9 and the air, and is partially incident on the other reflection body 10. The ambient light incident on the reflection surface 107 passes through the liquid crystal display panel 100, again, and produces a visual image or images on the image-producing plane 106. The other part of the ambient light reaches the other reflection surface 108, and is partially reflected on the reflection surface 108 toward the liquid crystal display panel 100. The reflection also passes through the liquid crystal display panel 100, and participates in the production of the visual image or images on the image producing plane 106. Thus, the semi-transparent reflector 101 recovers the ambient light by virtue of the reflection surface 108. Even though the reflectivity of each reflection surface 107/108 is smaller than the reflectivity of the prior art semi-transparent reflector 9a, the total amount of reflected light is more than the amount of the prior art semi-transparent reflector 9a.

On the other hand, when the user requests the liquid crystal display unit to produce the visual images on the image producing plane 106, the back light unit 105 is energized, and the back light is radiated to the semi-transparent reflector 101. The back light passes through the reflection bodies 10 and 9, and incident on the liquid crystal display panel 100. Although the back light is partially reflected, a substantial amount of back light is incident on the liquid crystal display panel 100, and participates in the production of the visual images.

The present inventor fabricated a sample of the liquid crystal display unit according to the present invention. The semi-transparent reflector 101 of the sample was equivalent in measures and material to the prior art semi-transparent reflector 9a. The present inventor measured the transmittance to the incident back light and the reflectivity to the incident ambient light. The present inventor confirmed that transmittance was higher than that of the prior art. Thus, the liquid crystal display unit was improved in the transmittance without sacrifice of the reflectivity.

Although an image of the ambience is carried on the ambient light, the image of the ambience is out of the field of view of the user, because the ambient light is obliquely reflected on the reflection surfaces 107/108. Moreover, the reflection on the reflection surface 108 advances in the direction different from that of the reflection on the reflection surface 107. In other words, the ambient light is scattered on the semi-transparent reflector 101 so that clear visual image or images are produced on the image-producing plane 106.

As will be understood from the foregoing description, the liquid crystal display unit according to the present invention has the semi-transparent reflector 101 with plural reflection surfaces 107/108, and both reflectivity and transmittance are improved rather than the prior art semi-transparent reflectors.

In the above-described embodiment, the reflection bodies 9 and 10 as a whole constitute a optical body, and the flat surface of the reflection body 9 and the waved surface 108 serve as two major surfaces.

### Second Embodiment

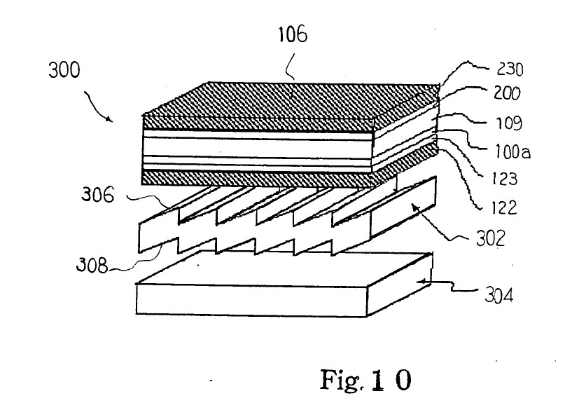

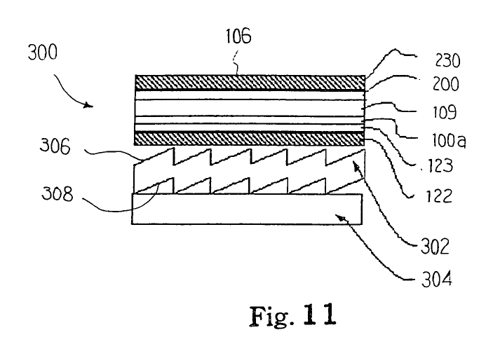

Turning to FIGS. 10 and 11 of the drawings, another liquid crystal display unit embodying the present invention largely comprises a liquid crystal display penal 300, a semi-transparent reflector 302 and a back light unit 304. The liquid crystal display panel 300 and the back light unit 304 are similar to those of the first embodiment, and components are labeled with the references same as those designating corresponding components without detailed description.

The semi-transparent reflector 302 is implemented by only one reflecting body, and two reflecting surfaces 306/308 are formed on both surfaces of the reflecting body 302. The reflecting body 302 is made of the transparent/semi-transparent substance selected from the group consisting of synthetic resin such as, for example, polyethylene terephthalate resin, polycarbonate resin, polyester resin, polyacrylic resin, glass and ITO. The reflecting surfaces 306/308 are same as the reflecting surfaces 107/108, and the ridgelines of the reflecting surfaces 306/308 are held in contact with the polarizing plate 122 and the light output surface of the back light unit 304. The waved surfaces of the reflecting body 302 are covered with neither metal nor particle-containing synthetic resin. Prism-like hollow spaces take place between the waved surfaces of the reflecting body 302, and are filled with the air.

In this instance, the reflection body 302 serves as an optical body, and the waved surfaces 306/308 are corresponding to two major surfaces.

Both reflectivity and transmittance are larger in value than those of the prior art semi-transparent reflectors. Ambient light is assumed to be incident on the image producing plane 106. The ambient light passes through the liquid crystal display panel 300, and is partially reflected on the reflection surface 306. The reflected ambient light passes through the liquid crystal display panel 300, and produces visual images on the image producing plane 106. The remaining ambient light passes through the reflection body 302, and is reflected on the reflection surface 308. The reflected ambient light passes through the reflection body 302 and liquid crystal display panel 300, and participates in the production of the visual images.

When the back light unit 304 is switched on, the back light is radiated from the back light unit 304 to the semi-transparent reflector 302. A substantial amount of back light is incident on the liquid crystal display panel 300, and participates in the production of the visual images.

The reflection surface 306 is in parallel to the reflection surface 308. The reflection surface 306 has the inclined rectangular surfaces, which are arranged in parallel to the inclined rectangular surfaces of the other reflection surfaces 308. This feature is desirable for the back light, because the incident angle is equal to the light output angle. The reflection surfaces 306/308 are arranged in such a manner that the direction of the back light is fallen within the visual field. The back light makes the visual image bright.

Thus, the semi-transparent reflector 302 achieves all the advantages of the first embodiment, and makes the visual image bright.

As will be appreciated from the foregoing description, the semi-transparent reflector according to the present invention has the plural reflection surfaces, and the reflection surfaces are not covered with any highly reflective low-transmissive layer. For this reason, the semi-transparent reflector achieves a large transmittance without sacrifice of the reflectivity.

The liquid crystal display unit is equipped with the semi-transparent reflector so that the bright clear image is produced with assistance of both back light and ambient light.

Although particular embodiments of the present invention have been shown and described, it will be apparent to those skilled in the art that various changes and modifications may be made without departing from the spirit and scope of the present invention.

For example, the semi-transparent reflector according to the present invention may have more than two reflecting surfaces. The semi-transparent reflector with more than two reflecting surfaces may be implemented by a combination of the reflecting bodies 11 and 10.

The liquid crystal display panel may be of the twisted nematic active matrix type. In this instance, the counter electrode 118 is not incorporated in the substrate structure 100a, but is a part of the other substrate structure 200.

A liquid crystal display unit may have a light diffuser between the transparent substrate 210 and the polarizing plate 230 instead of the light diffusing adhesive compound layer 123.

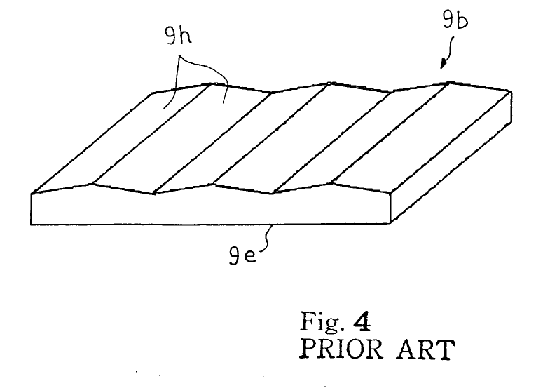

A reflection body may have the waved surface, which is similarly formed as the waved surface shown in FIG. 4. The waved surface is not covered with the metal layer or particle-containing synthetic resin layer, and constituted by inclined rectangular surfaces. The ridgeline of each inclined rectangular surface is abutted to the ridgeline of the adjacent inclined rectangular surface, and the bottom line of the inclined rectangular surface is abutted to the bottom line of the other adjacent inclined rectangular surface. A pair of reflection bodies is combined like the semi-transparent reflector 101. Otherwise, both surfaces are waved as similar to the semi-transparent reflector 302.

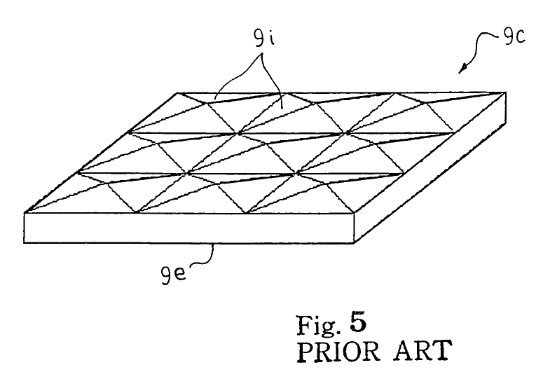

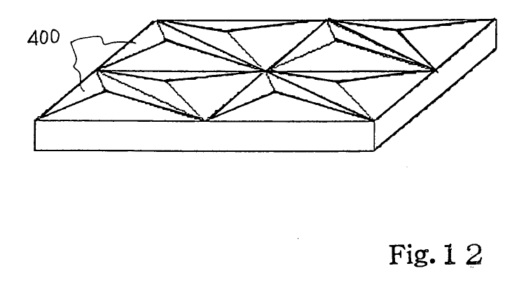

Another reflection body may have the waved surface or surfaces, which are constituted by the arrays of triangular pyramids 400 shown in FIG. 12. The array of triangular pyramids may be replaced with the array of pyramids shown in FIG. 5. The waved surfaces are not covered with any low trans-missive high reflective layer such as the metal layer or the particle-containing synthetic resin layer.

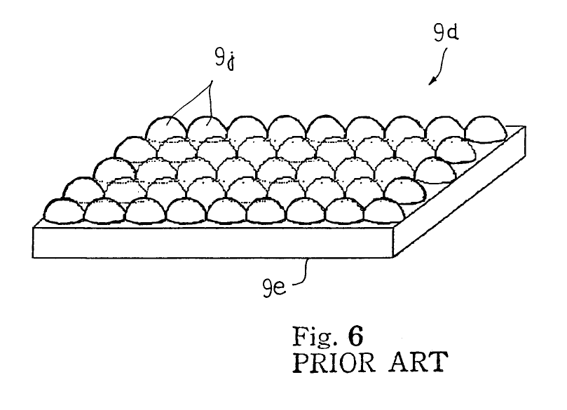

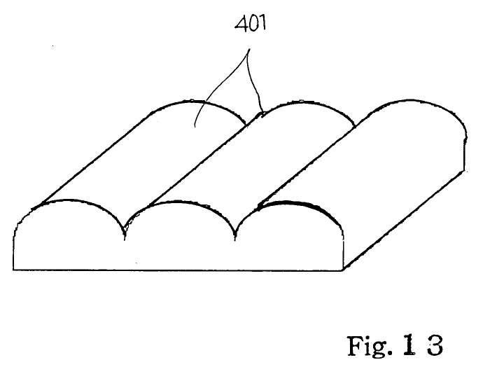

Yet another reflection body may have the waved surface or surfaces, which are constituted by the arrays of semi-circular cylinders 401 shown in FIG. 13. The waved surfaces are not covered with any low transmissive high reflective layer such as the metal layer or the particle-containing synthetic resin layer. A reflection body may have a waved surface or surfaces, which are constituted by arrays of projection shown in FIG. 6. An array of semispherical projections may be used for forming the waved surfaces. The waved surfaces are not covered with any low transmissive high reflective layer such as the metal layer or the particle-containing synthetic resin layer.

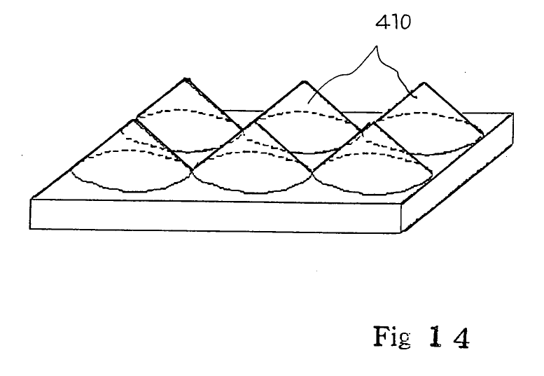

Still another reflection body may have the waved surface or surfaces, which are constituted by the arrays of circular cones 410 shown in FIG. 14. The waved surfaces are not covered with any low transmissive high reflective layer such as the metal layer or the particle-containing synthetic resin layer.

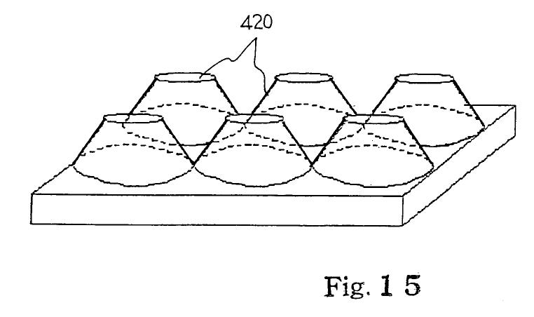

Yet another reflection body may have the waved surface or surfaces, which are constituted by the arrays of frustums of circular cones 420 shown in FIG. 15. The waved surfaces are not covered with any low transmissive high reflective layer such as the metal layer or the particle-containing synthetic resin layer.

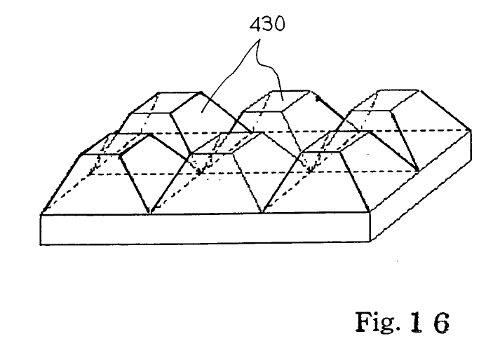

Still another reflection body may have the waved surface or surfaces, which are constituted by the arrays of frustums of pyramids 430 shown in FIG. 16. The waved surfaces are not covered with any low transmissive high reflective layer such as the metal layer or the particle-containing synthetic resin layer.

A reflection polarizing plate may be attached to the surface of the polarizing plate 122 on the opposite side to the liquid crystal display panel. The reflection polarizing plate has a reflection axis substantially perpendicular to the transmission axis, and the reflection polarizing plate is arranged in such a manner that the transmission axis of the reflection polarizing plate is substantially in parallel to the transmission axis of the polarizing plate 122. The back light and reflected ambient light have light components, which are polarized in the direction perpendicular to the transmission axis of the polarizing plate 122. The light components are not absorbed by the polarizing plate 122, but is reflected on the reflection polarizing plate toward the semi-transparent reflector. When the light component is reflected, the light component is partially converted to light component, which is permitted to pass the liquid crystal layer. Thus, the reflection polarizing plate enhances the transmittance and reflectivity of the semi-transparent reflector.

What is claimed is:

1. A semi-transparent reflecting plate including plural reflecting surfaces extending substantially over an entire surface of a reflecting plate and not only permitting light to pass therethrough, but also reflecting the light on said reflecting surfaces.

2. The semi-transparent reflecting plate as set forth in claim 1, wherein said reflecting plate includes at least a plate having both surfaces each serving as the reflecting surfaces.
